(19) United States
(12) Patent Application Publication
(10) Pub. No.: US 2019/0316658 A1
(43) Pub. Date: Oct. 17, 2019

(54) CHECK VALVE ASSEMBLY STRUCTURE FOR HYDRAULIC TENSIONER

(71) Applicant: BorgWarner Inc., Auburn Hills, MI (US)

(72) Inventor: Young Taek SUN, Gyeonggi-do (KR)

(21) Appl. No.: 16/474,807

(22) PCT Filed: Jan. 4, 2017
(86) PCT No.: PCT/US2017/012114

§ 371 Date: Jun. 28, 2019

(51) Int. Cl. F16H 7/08

(52) U.S. Cl. CPC F16H 7/08; F16H 2007/0806; F16H 2007/0878; F16H 2007/0859; F16H 2007/0812

(57) ABSTRACT

This invention relates to a hydraulic tensioner comprising a tensioner body, a hollow piston, a hydraulic pressure chamber, a piston spring, and a check valve assembly. The check valve assembly includes a ball, a spring, and a retainer that are assembled directly on the tensioner body. The retainer is preferably press-fit onto the tensioner body. The check valve assembly preferably does not include a seal or a seat.

### BACKGROUND OF THE INVENTION

### Field of the Invention

The invention pertains to the field of hydraulic tensioners. More particularly, the invention pertains to a check valve directly assembled on the tensioner body.

### Description of Related Art

Check valves allow oil into the hydraulic pressure chamber (forward flow) of a hydraulic tensioner and prevent flow of oil out of the hydraulic pressure chamber to the source, such that oil in the reservoir provides damping when the piston is forced back into the bore (checked flow).

Conventional check valves are composed of five components: a retainer, a spring, a check valve, a seat, and a seal. In some designs, the seal includes a vent to meet backflow requirements.

A prior art hydraulic tensioner 1 with a seal 30 is shown in FIG. 1. The hydraulic tensioner 1 includes a tensioner body 10, a retaining pin 15, a piston 12, a vent disk 13 (to reduce volume of the tensioner), a hydraulic pressure chamber 14, a conventional check valve assembly 20, and a spring 16. The tensioner body 10 defines a cylindrical bore 11 for slidably receiving the hollow piston 12. One end 19 of the bore 11 contains an inlet 17 in fluid communication with an external supply of pressurized fluid (not shown). The hydraulic pressure chamber 14 is defined by an inner circumference of the hollow piston 12, bore 11, compression spring 16 and the check valve assembly 20. The compression spring 16 biases the piston 12 away from the inlet 17.

The conventional check valve assembly 20 is located at the base of the piston bore 11 to allow hydraulic fluid to fill the space in the piston bore 11. The check valve assembly 20 includes a retainer 22, a spring 24, a ball 26, a seat 28, and the seal 30. The retainer 22 is shaped like a hat to partially surround the spring 24, the ball 26, and the seat 28. In some conventional check valves, the seal 30 is a vent disk.

### SUMMARY OF THE INVENTION

In one embodiment, a hydraulic tensioner includes a tensioner body having a bore in fluid communication with a source of pressurized fluid through an inlet, a hollow piston slidably received within the bore, a hydraulic pressure chamber defined by the hollow piston and the bore of the tensioner body, a piston spring received within the hydraulic pressure chamber for biasing the piston away from the inlet and a check valve assembly located in the tensioner body. The check valve assembly includes a check valve retainer, a ball, and a check valve spring located between the ball and the retainer. The ball and the check valve spring are integrally assembled on the tensioner body and the check valve retainer is assembled onto the tensioner body.

In another embodiment, a method of assembling a hydraulic tensioner including a tensioner body having a bore in fluid communication with a source of pressurized fluid through an inlet, a hollow piston slidably received within the bore, a hydraulic pressure chamber defined by the hollow piston and the bore of the tensioner body, a piston spring received within the hydraulic pressure chamber for biasing the piston away from the inlet, and a check valve assembly including a check valve retainer, a ball, and a check valve spring located between the ball and the check valve retainer, comprises the step of directly assembling the check valve retainer onto the tensioner body.

In another embodiment, a check valve assembly for a hydraulic tensioner including a tensioner body includes a retainer shaped to be directly assembled into the tensioner body, a ball, and a check valve spring located between the ball and the check valve retainer. The check valve assembly does not include a seal or a valve seat.

### BRIEF DESCRIPTION OF THE DRAWINGS

FIG. 1 shows a schematic of a prior art hydraulic tensioner.

FIG. 2A shows perspective view of a hydraulic tensioner in an embodiment of the present invention.

FIG. 2B shows a top view of the hydraulic tensioner of FIG. 2A.

FIG. 2C shows a bottom view of the hydraulic tensioner of FIG. 2A.

FIG. 2D shows a front view of the hydraulic tensioner of FIG. 2A.

FIG. 2E shows a back view of the hydraulic tensioner of FIG. 2A.

FIG. 2F shows a schematic of the hydraulic tensioner of FIG. 2A.

FIG. 3 shows a cross-sectional view of the hydraulic tensioner along lines A-A of FIG. 2D.

FIG. 4 shows the retainer of the check valve assembly in the hydraulic tensioner in FIG. 2A.

FIG. 5A shows a schematic of the check valve components of a conventional hydraulic tensioner.

FIG. 5B shows a schematic of the check valve components in a hydraulic tensioner in one embodiment of the present invention.

FIG. 5C shows an exploded schematic view of the check valve components of FIG. 5A.

FIG. 5D shows an exploded schematic view of the check valve components of FIG. 5B.

FIG. 6A shows a perspective view of a hydraulic tensioner in another embodiment of the present invention.

FIG. 6B shows a top view of the hydraulic tensioner of FIG. 6A.

FIG. 6C shows a bottom view of the hydraulic tensioner of FIG. 6A.

FIG. 6D shows a front view of the hydraulic tensioner of FIG. 6A.

FIG. 6E shows a back view of the hydraulic tensioner of FIG. 6A.

FIG. 7 shows a cross-sectional view of the hydraulic tensioner along lines A-A of FIG. 6D.

FIG. 8A shows a perspective view of the non-vent side of a vent disk/retainer assembly.

FIG. 8B shows a perspective view of the vent side of the vent disk/retainer assembly.

FIG. 8C shows another view of the vent disk/retainer assembly of FIG. 8A.

FIG. 8D shows a cross-sectional view of the vent disk retainer along lines A-A of FIG. 8C.

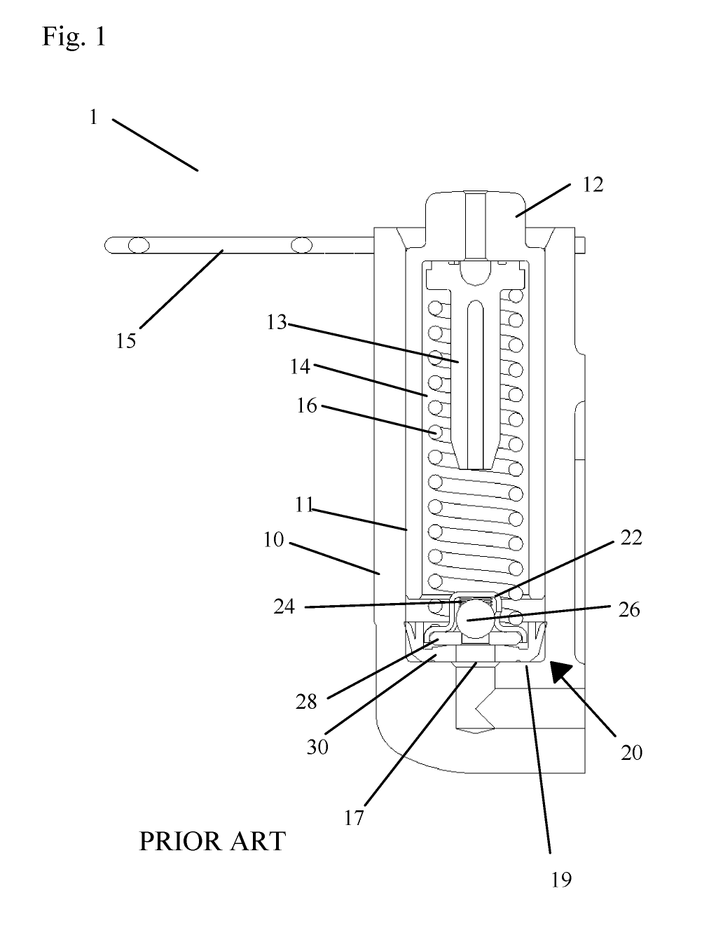

### DETAILED DESCRIPTION OF THE INVENTION

In a new check valve structure, the check valve ball and spring are integrally assembled on the tensioner body/housing and the check valve retainer is preferably press-fitted on the tensioner body. Alternatively, the check valve retainer is bolted or otherwise fastened onto the tensioner body. Some embodiments include a vent type retainer to provide an oil vent function. By using a check valve ball and spring integrally assembled on the tensioner body, the part cost for the tensioner is decreased and no special machining is needed for the check valve assembly. Since the check valve components are assembled on the tensioner, no pre-assembly of the check valve components is required. In addition, there is no longer a need for a seat or seal, which reduces part cost.

The tensioner body has a step shaped oil hole with a 37.5 degree chamfer. The ball check valve in embodiments of the present invention directly contacts the chamfer on the tensioner body for oil flow control. A check valve spring is located between the check valve retainer and the ball check valve. The check valve retainer preferably has a simple shape, such as a round shape, and a small hole in the center. The check valve retainer shape may be easily changed to apply a plastic vent for a check valve and vent assembly.

The check valve retainer is preferably press-fit onto the tensioner body so the ball check valve and check valve spring are able to work at the correct location. When oil flows into the hydraulic pressure chamber (forward flow), the ball check valve moves away from the inlet. When the ball moves towards the inlet, it prevents back flow of oil.

Conventional check valves have either seals or vents. The check valve assemblies described herein preferably replace a seal type check valve and may be shaped like a simple circle with a small hole. In other embodiments, a different shaped retainer is used to accommodate a vent. In these embodiments, the retainer includes a hole and a vent with a tortuous path, as well as a small slot style oil passage for control of the leakage amount.

During performance of the engine, the ball check valve contacts and impacts the tensioner body. In preferred embodiments, the tensioner body is made of steel or cast iron to avoid the risk of wear or deformation from the impact of the ball. In some preferred embodiments, the check valve retainer is also made of steel.

The ball moves towards and away from the inlet in response to the pressure in the hydraulic pressure chamber and low pressure reservoir, and the check valve spring supports ball motion. The check valve retainer retains the ball and check valve spring.

In some embodiments where wear may be high, a seat, such as a steel seat, is also included to limit the risk of wear or deformation due to impact of the ball check valve.

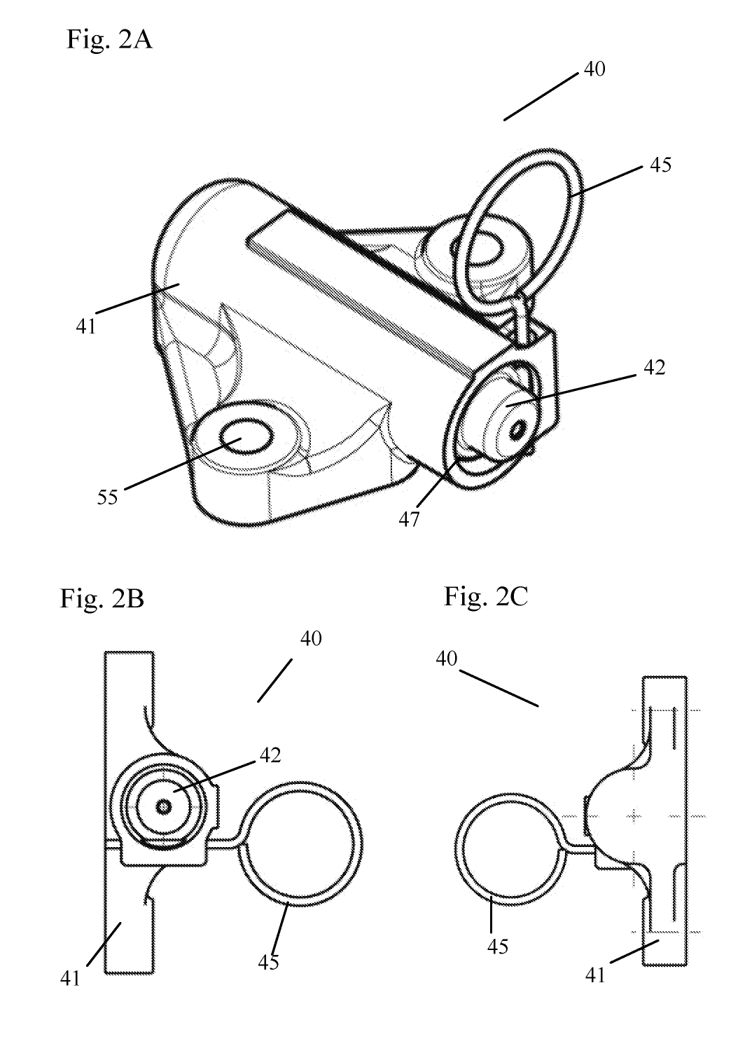

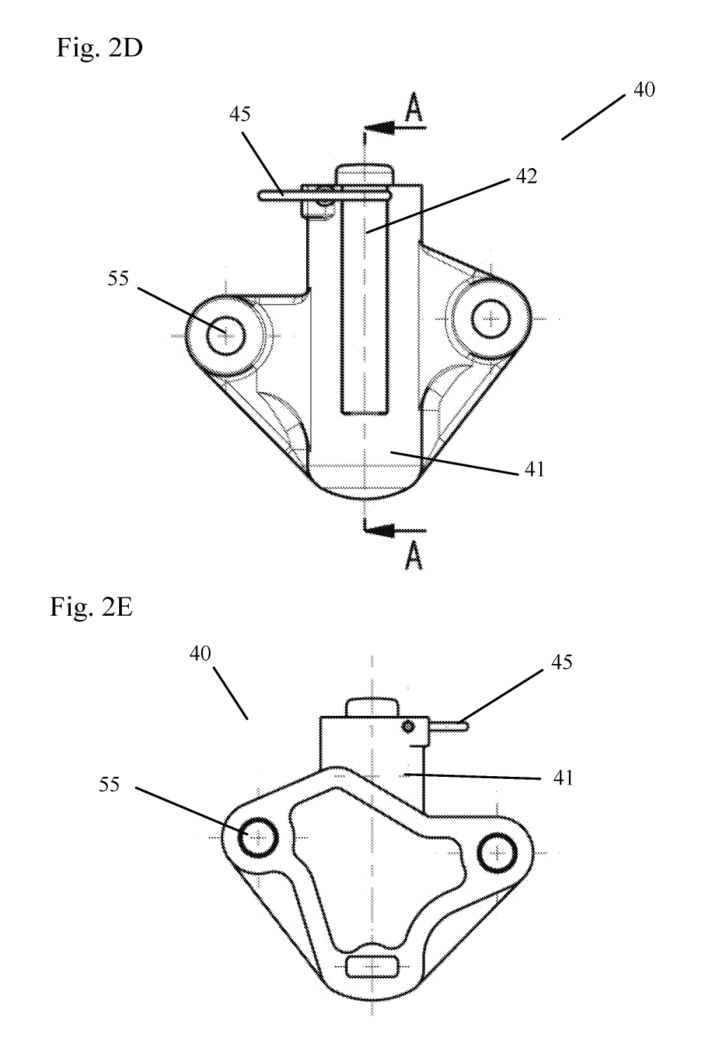

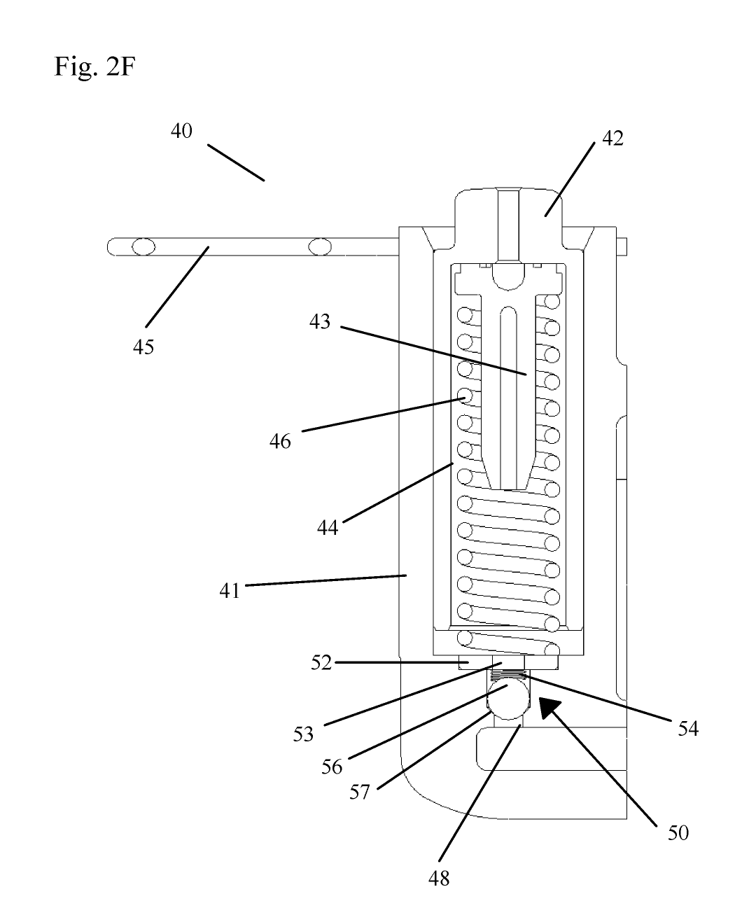

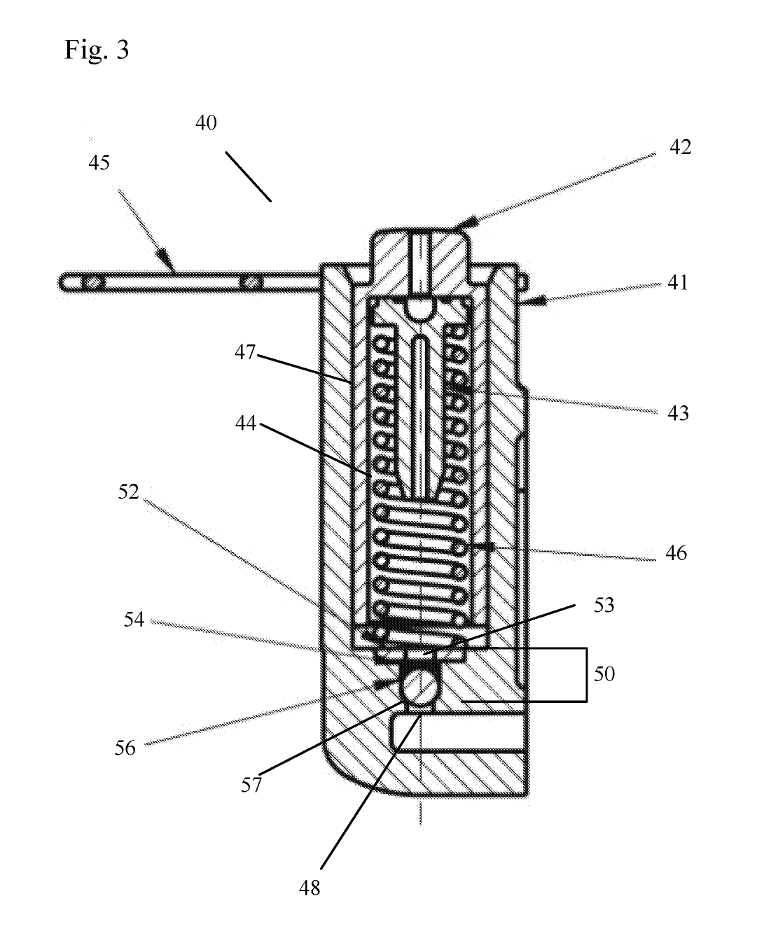

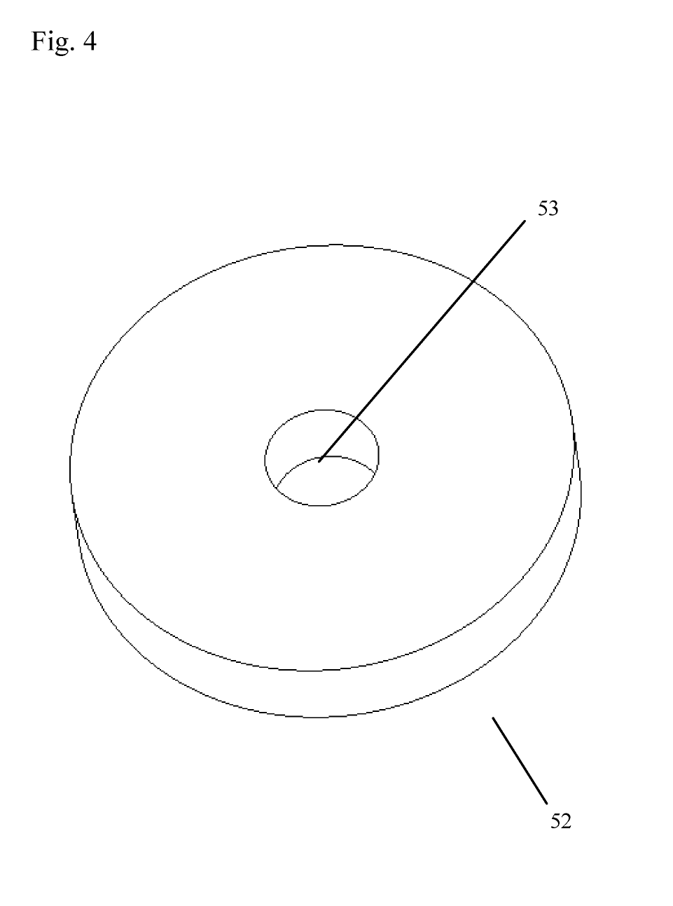

FIGS. 2A through 4 show a first embodiment of a hydraulic tensioner 40 with a check valve assembly 50. The hydraulic tensioner 40 includes a tensioner body 41, a retaining pin 45, a piston 42, a vent disk 43 (to reduce volume of the tensioner), a hydraulic pressure chamber 44 and a spring 46. The tensioner body 41 defines a cylindrical bore 47 for slidably receiving the hollow piston 42. One end of the bore 47 contains an inlet 48 in fluid communication with an external supply of pressurized fluid (not shown). The hydraulic pressure chamber 44 is defined by an inner circumference of the hollow piston 42, bore 47, compression spring 46 and the check valve assembly 50. The compression spring 46 biases the piston 42 away from the inlet 48.

Although the tensioner body 41 is shown having at least one mounting hole 55 for mounting the tensioner body 41 to a stationery surface (not shown), the tensioner 40 may alternatively be mounted in a cartridge-style mounting arrangement within the spirit of the invention, where the tensioner 40 is mounted by a thread on the outside of the body 41.

The check valve assembly 50 includes a retainer 52, a ball 56 and a spring 54. The spring 54 is located between the retainer 52 and the ball 56. The retainer 52 preferably has a small hole 53 in the center. While a round shape is shown for the retainer 52 in the figures, any simple shape that is easily manufactured could be used.

The tensioner body has a step shaped oil hole 57, preferably with a 37.5 degree chamfer. The ball 56 directly contacts the chamfer on the tensioner body for oil flow control.

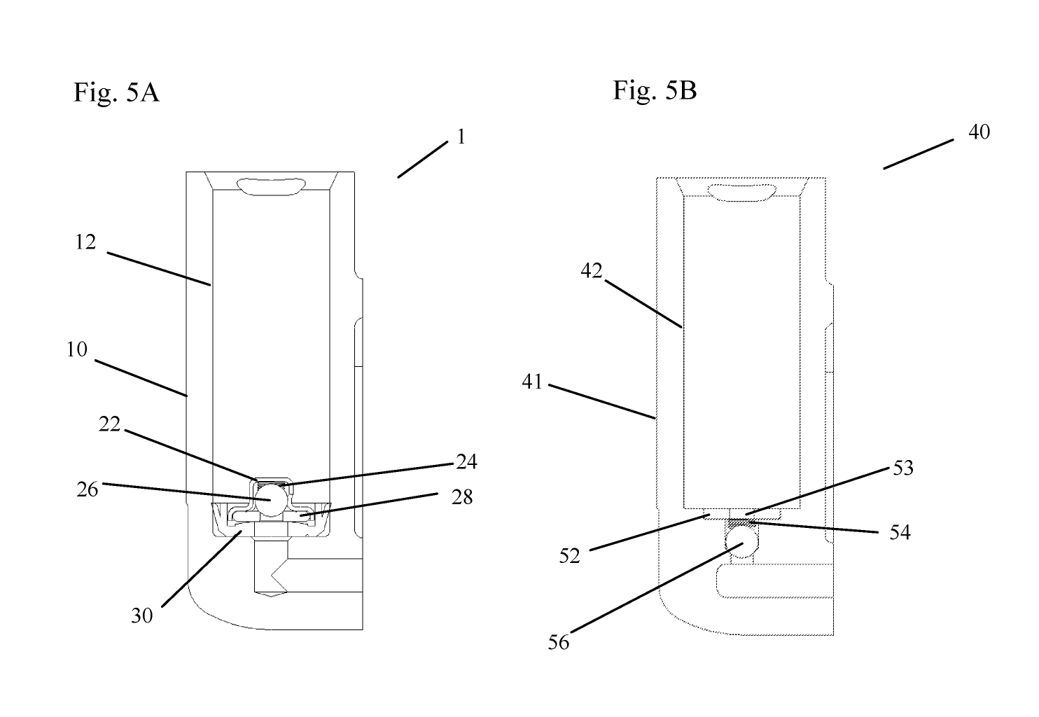

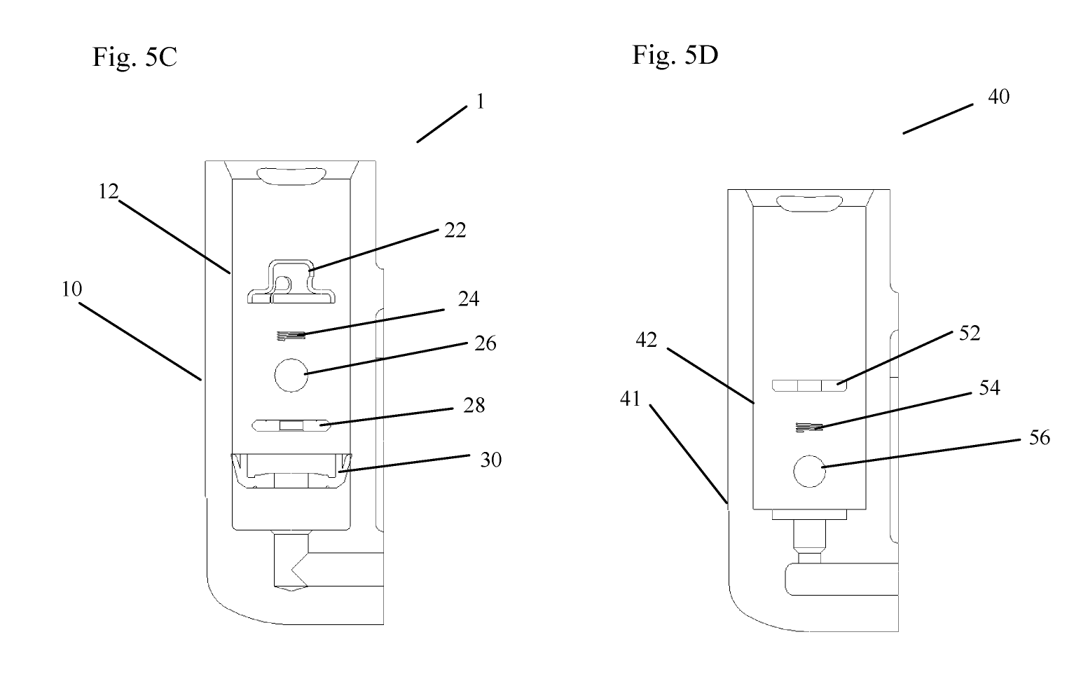

FIGS. 5A-5D highlight some of the differences between the check valve components of a conventional hydraulic tensioner 1 (shown in FIGS. 5A and 5C) and the check valve components of the first embodiment of a hydraulic tensioner 40 of the present invention (shown in FIGS. 5B and 5D). Most of the other components of the hydraulic tensioners 1, 40 have been removed for clarity.

The prior art check valve retainer 22 has a hat shape, while the check valve retainer 52 has a simple round shape with a single hole 53. In addition, the seat 28 and seal 30 are omitted in the check valve assembly 50 in FIGS. 5B and 5D. Both of these changes make the check valve assembly 50 simpler and easier to manufacture. In addition, the retainer 52 may be press fitted into the tensioner body 41 and the retainer 52, the spring 54, and the ball 56 are preferably assembled directly onto the tensioner body 41. The ball 56 directly contacts the tensioner 41 without any intervening parts.

Since the check valve components are assembled on the tensioner body, no pre-assembly of the check valve components are required. In addition, there is no longer a need for a seat or seal, which reduces part cost.

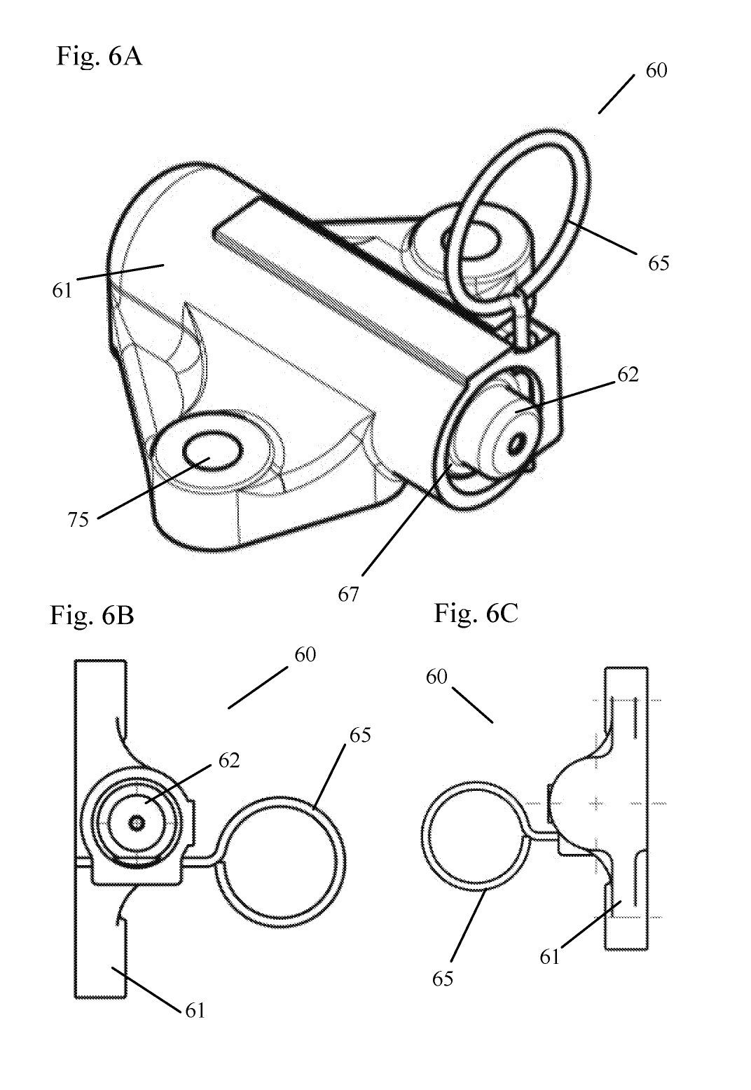

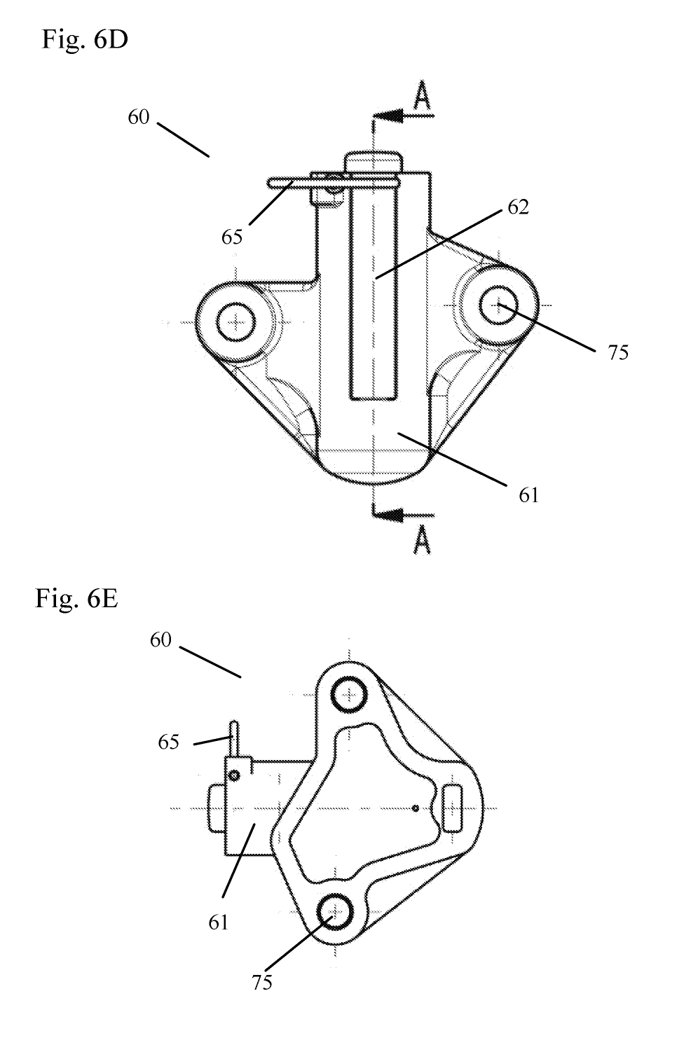

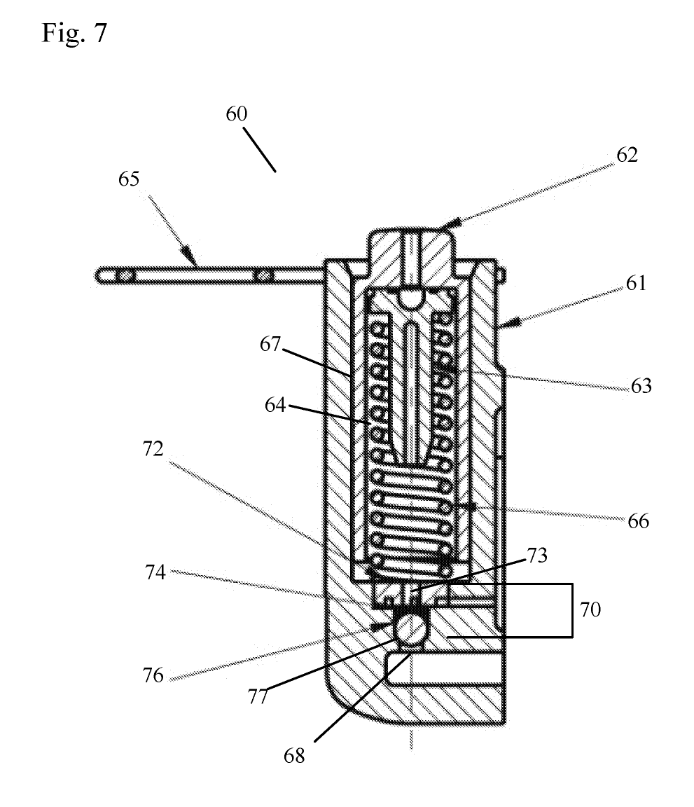

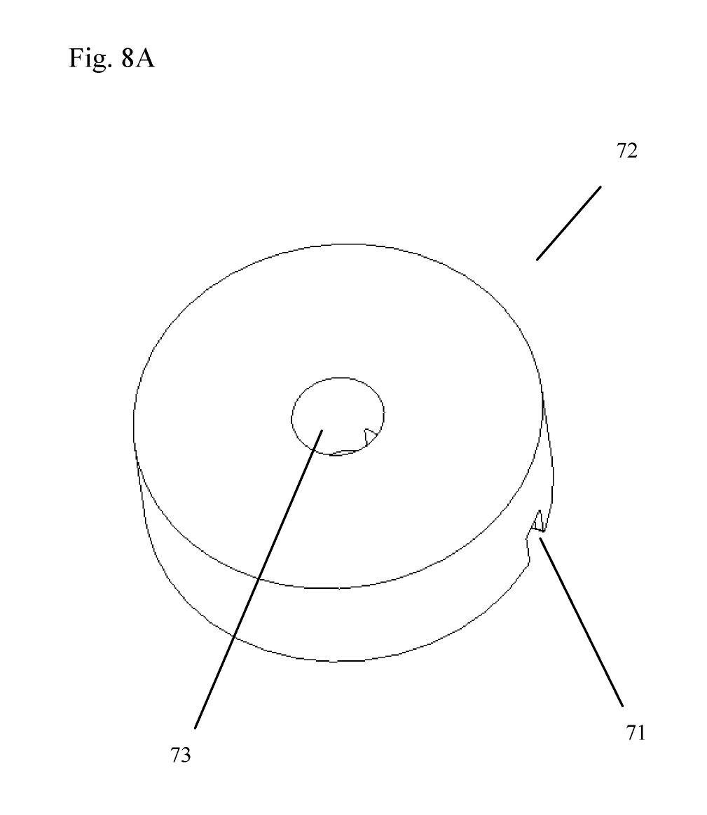

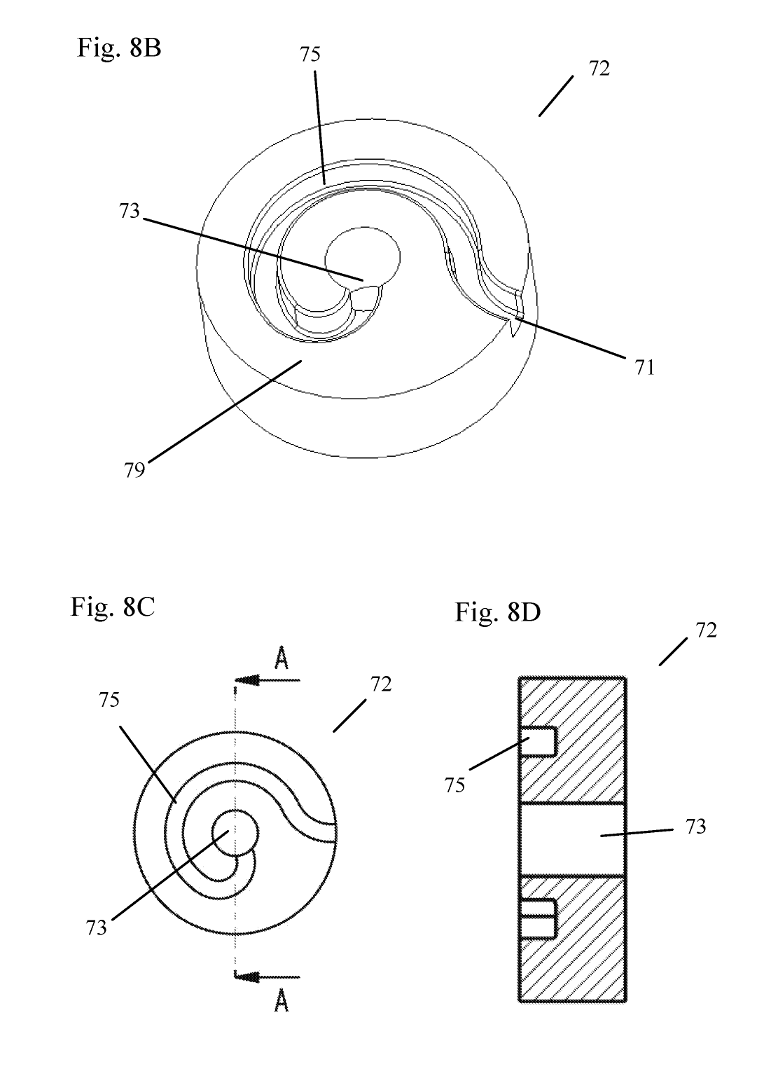

FIGS. 6A through 8 show a second embodiment of a hydraulic tensioner 60 with a check valve assembly 70 including a retainer 72, a ball 76 and a spring 74. The spring 74 is located between the retainer 72 and the ball 76. Unlike the first embodiment, the retainer 72 includes a vent disk 79 with a tortuous path 75 in this embodiment. The retainer 72 in this embodiment includes a hole 73, but also includes a small slot style oil passage 71 for control of the leakage amount.

The hydraulic tensioner 60 also includes a tensioner body 61, a retaining pin 65, a piston 62, a vent disk 63 (to reduce volume of the tensioner), a hydraulic pressure chamber 64 and a spring 66. The tensioner body 61 has a step shaped oil hole 77, preferably with a 37.5 degree chamfer The ball check valve 76 directly contacts the chamfer on the tensioner body for oil flow control.

The tensioner body 61 defines a cylindrical bore 67 for slidably receiving the hollow piston 62. One end of the bore 67 contains an inlet 68 in fluid communication with an external supply of pressurized fluid (not shown). The hydraulic pressure chamber 64 is defined by an inner circumference of the hollow piston 62, bore 67, compression spring 66 and the check valve assembly 70. The compression spring 66 biases the piston 62 away from the inlet 68.

Although the tensioner body 61 is shown having at least one mounting hole 75 for mounting the tensioner body 61 to a stationery surface (not shown), the tensioner 60 may alternatively be mounted in a cartridge-style mounting arrangement within the spirit of the invention, where the tensioner 60 is mounted by a thread on the outside of the body 61.

While the check valve assembly is described herein for hydraulic tensioners, it could alternatively be used in a VCT system.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A hydraulic tensioner, comprising:
a tensioner body having a bore in fluid communication with a source of pressurized fluid through an inlet;
a hollow piston slidably received within the bore;
a hydraulic pressure chamber defined by the hollow piston and the bore of the tensioner body;
a piston spring received within the hydraulic pressure chamber for biasing the piston away from the inlet; and
a check valve assembly located in the tensioner body, comprising:
a check valve retainer;
a ball; and
a check valve spring located between the ball and the retainer;
wherein the ball and the check valve spring are integrally assembled on the tensioner body and the check valve retainer is assembled onto the tensioner body.

2. The hydraulic tensioner of claim 1, wherein the check valve retainer is press fit onto the tensioner body.

3. The hydraulic tensioner of claim 1, wherein the check valve assembly is not preassembled before being placed in the tensioner body.

4. The hydraulic tensioner of claim 1, wherein the ball directly contacts the tensioner body without any intervening parts.

5. The hydraulic tensioner of claim 1, wherein the check valve assembly does not include a seal.

6. The hydraulic tensioner of claim 1, wherein the check valve assembly does not include a valve seat.

7. The hydraulic tensioner of claim 1, wherein the check valve retainer comprises a substantially cylindrical retainer body defining a hole in a center of the retainer body.

8. The hydraulic tensioner of claim 1, wherein the check valve retainer comprises a substantially cylindrical retainer body defining a hole in a center of the retainer body and a passage with a tortuous path.

9. A method of assembling a hydraulic tensioner comprising a tensioner body having a bore in fluid communication with a source of pressurized fluid through an inlet, a hollow piston slidably received within the bore, a hydraulic pressure chamber defined by the hollow piston and the bore of the tensioner body, a piston spring received within the hydraulic pressure chamber for biasing the piston away from the inlet, and a check valve assembly comprising a check valve retainer, a ball, and a check valve spring located between the ball and the check valve retainer, comprising the step of directly assembling the check valve retainer onto the tensioner body.

10. The method of claim 9, wherein the step of directly assembling the check valve retainer onto the tensioner body comprises the substep of press-fitting the check valve retainer onto the tensioner body.

11. The method of claim 9, further comprising the step of assembling the ball and the check valve spring onto the tensioner body.

12. The method of claim 10, wherein the ball directly contacts the tensioner body without any intervening parts.

13. The method of claim 9, wherein the check valve assembly is not preassembled before being placed in the tensioner body.

14. The method of claim 9, wherein the check valve retainer comprises a substantially cylindrical retainer body defining a hole in a center of the retainer body.

15. The method of claim 9, wherein the check valve retainer comprises a substantially cylindrical retainer body defining a hole in a center of the retainer body and a passage with a tortuous path.

16. A check valve assembly for a hydraulic tensioner comprising a tensioner body comprising:
a) a retainer shaped to be directly assembled into the tensioner body;
b) a ball; and
c) a check valve spring located between the ball and the check valve retainer;
wherein the check valve assembly does not include a seal; and
wherein the check valve assembly does not include a valve seat.

17. The check valve assembly of claim 16, wherein the retainer is shaped to be press fit into the tensioner body.

18. The check valve assembly of claim 16, wherein the check valve assembly is not preassembled before being placed in the tensioner body.

19. The check valve assembly of claim 16, wherein the ball directly contacts the tensioner body without any intervening parts.

20. The check valve assembly of claim 16, wherein the check valve retainer comprises a substantially cylindrical retainer body defining a hole in a center of the retainer body.

21. The check valve assembly of claim 16, wherein the check valve retainer comprises a substantially cylindrical retainer body defining a hole in a center of the retainer body and a passage with a tortuous path.
